(19) United States
(12) Patent Application Publication
(10) Pub. No.: US 2026/0117541 A1
(43) Pub. Date: Apr. 30, 2026

(54) Sock Anchor Installation System and Method

(71) Applicants: Terence Foster, Cambridgeshire (GB); Benoit Pierre Augustin PERICARD, Cissé (FR)

(72) Inventors: Terence Foster, Cambridgeshire (GB); Benoit Pierre Augustin PERICARD, Cissé (FR)

(21) Appl. No.: 19/477,971

(22) PCT Filed: Feb. 20, 2024
(86) PCT No.: PCT/EP2024/054246

§ 371 Date: Oct. 23, 2025

(30) Foreign Application Priority Data
Apr. 28, 2023 (GB) 2306326.6

(51) Int. Cl. E04G 23/02

(52) U.S. Cl. CPC E04G 23/0296

(57) ABSTRACT

A sock anchor installation system and method of installation, where the sock anchor installation system includes an elongate tension member, a textile sleeve arranged to envelop the elongate tension member; and an elongate hollow tube attachable to one end of an injection mechanism, which is configured to be filled with and to eject cementitious material into a preformed cavity. The textile sleeve is configured to be received over the elongate hollow tube and the elongate tension member is configured to be inserted into the elongate hollow tube for installation into the cavity. The method involves installing the elongate tension member, the textile sleeve and the elongate hollow tube as a unit into the preformed cavity. Upon injection of cementitious material into the cavity the elongate tension member and the textile sleeve are simultaneously released from the hollow tube into the preformed cavity.

### FIELD OF INVENTION

The present invention relates to a product and process for reinforcing and repairing masonry, concrete or brick structures. In particular, the invention relates to a sock anchor installation system and a related method of installation.

### BACKGROUND TO THE INVENTION

Sock anchors are known for repairing, by reinforcement, masonry, concrete and brick structures.

Typically, sock anchors are made of a rigid bar or rod, which is covered in a textile sock. The sock anchor is inserted into an elongate cavity in the building or structure for repair or reinforcement. The cross-sectional dimension of the cavity is larger than the cross-sectional dimension of the sock anchor, such that the cavity can be filled with cementitious material which embeds the sock anchor in the cavity to reinforce the structure in which the cavity is created. The cavity, for receiving the sock anchor, is typically created in an area of damage, weakness or subsidence in a structure. The sock anchor is then inserted into the cavity, then the sock and the surrounding cavity are filled with cementitious material such that the sock anchor becomes embedded within the structure. The embedded sock anchor repairs and reinforces the damaged area.

Sock anchors are often used such that full demolition and rebuild of a part of a structure can be avoided.

A sock anchor device operates by inserting the anchor system into a cavity before injecting the cavity with cementitious grout. The cementitious grout is operable to expand the sock to fill the cavity surrounding the rod. The sock material is flexible and porous such that the sock can deform to the shape and form of the cavity to provide mechanical and chemical bonding of the anchor device to the internal surface of the cavity. The sock material typically acts to contain the cement to avoid seepage of the cement into small cracks extending from the cavity surface into the structure because such seepage may result in crack propagation and failure of the structure surrounding the anchor.

### SUMMARY OF THE INVENTION

A first aspect of the present invention provides a sock anchor installation system comprising:
an elongate tension member;
a textile sleeve arranged to envelop the elongate tension member;
an elongate hollow tube attachable to one end of an injection mechanism configured to be filled with cementitious material;
wherein the textile sleeve is configured to be received over the elongate hollow tube and the elongate tension member is configured to be inserted into the elongate hollow tube and wherein the elongate tension member, the textile sleeve and the elongate hollow tube are configured to be installed within a preformed cavity as a unit and the elongate tension member and the textile sleeve are configured to be substantially simultaneously released from the nozzle into the preformed cavity upon injection of cementitious material from the injection mechanism into the hollow tube and into the preformed cavity.

The sock anchor installation system may further comprise a stopper, operable to be inserted into a mouth of the preformed cavity upon retraction of the hollow tube from the cavity.

The elongate tension member may be metal, for example steel, mild steel, stainless steel etc.

The elongate tension member may be a helical spiral rod/bar. Alternatively, the elongate tension member may comprise threaded rod. It will be appreciated the shape and form of the helical spiral rod or threaded rod provides a profile with a rising and falling/changing surface profile which provides crevices into which the cementitious material can flow to improve mechanical and chemical bonding of the cementitious material to the components of the sock anchor and the cavity in which the sock anchor is inserted.

The textile sleeve is configured to deform to take up the shape of the cavity in which it is inserted when the cementitious material is injected into the cavity in which the textile sleeve and tension member are inserted. The textile sleeve is made from an elastic textile. The cementitious material is fluidic such that it fills and pushes the textile sleeve to fill the cavity and surrounds the inner tension member to create a solid anchor in the structure in which the sock anchor is installed.

When the cementitious material sets or cures, the embedded inner tension member provides localised reinforcement of the structure in which it is installed.

A further aspect of the present invention provides a method of installing a sock anchor into a preformed cavity in a structure, the method comprising the steps of:
taking or cutting an elongate tension member to a length that corresponds with a depth of the preformed cavity;
taking or cutting a textile sleeve to a length that corresponds with a depth of the preformed cavity, wherein, in use the textile sleeve provides an outer sleeve of the sock anchor, when installed and is arranged to envelop cementitious material and the elongate tension member;
taking or cutting an elongate hollow tube to a length that corresponds with a depth of the preformed cavity;
attaching the elongate hollow tube to an outlet end of an injection mechanism, wherein the injection mechanism is configured to contain and dispense cementitious material;
priming the hollow tube until at least partially filled with cementitious material;
inserting the tension member into the hollow tube thereby coating the tension member in cementitious material;
applying the textile sleeve to the elongate hollow tube thereby encapsulating the hollow tube;
inserting, as a unit, the textile sleeve, the hollow tube and the tension member into the preformed cavity until fully inserted;
injecting cementitious material into the hollow tube and preformed cavity such that the cementitious material fills the preformed cavity and at the same time pushes the hollow tube from the preformed cavity whilst leaving the textile sleeve and tension member inside the preformed cavity.

The method may further comprise plugging a mouth of the preformed cavity with a stopper.

The method may further comprise removing the stopper and filling the mouth of the preformed cavity with a material that corresponds at least in colour with the structure in which the preformed cavity is formed.

The method may further comprise preparatory steps of creating a preformed cavity in a structure and cleaning the preformed cavity.

### BRIEF DESCRIPTION OF THE DRAWINGS

Embodiments of the invention are further described hereinafter with reference to the accompanying drawings, in which:

FIG. 1 illustrates the components of a mini sock anchor according to an embodiment of the present invention;

FIGS. 2a and 2b illustrate preparation of a cavity for receiving the mini sock anchor of FIG. 1;

FIGS. 3a to 3c illustrate preparation of an installation mechanism configured to install the mini sock anchor of FIG. 1;

FIGS. 4a to 4c illustrates assembling the mini sock anchor components and the installation mechanism in preparation for installing the mini sock ancho in the cavity prepared in FIGS. 2a and 2b.

FIGS. 5a and 5b illustrate installation of the assembled installation system and removal of the installation mechanism when installation is complete;

FIG. 6 illustrates the final step of the installation process, where a plug is inserted in the entrance to the cavity to allow the cementitious material to set.

### DESCRIPTION

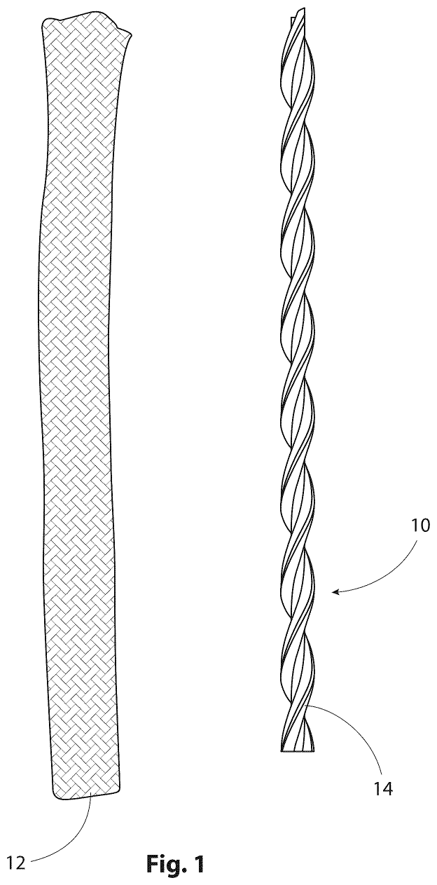

Referring to FIGS. 1 to 6, a sock anchor 10 and sock anchor installation process is illustrated.

FIG. 1 shows the separate components of the sock anchor 10 i.e., a textile sleeve 12, also referenced as a sock 12 and a tension member 14.

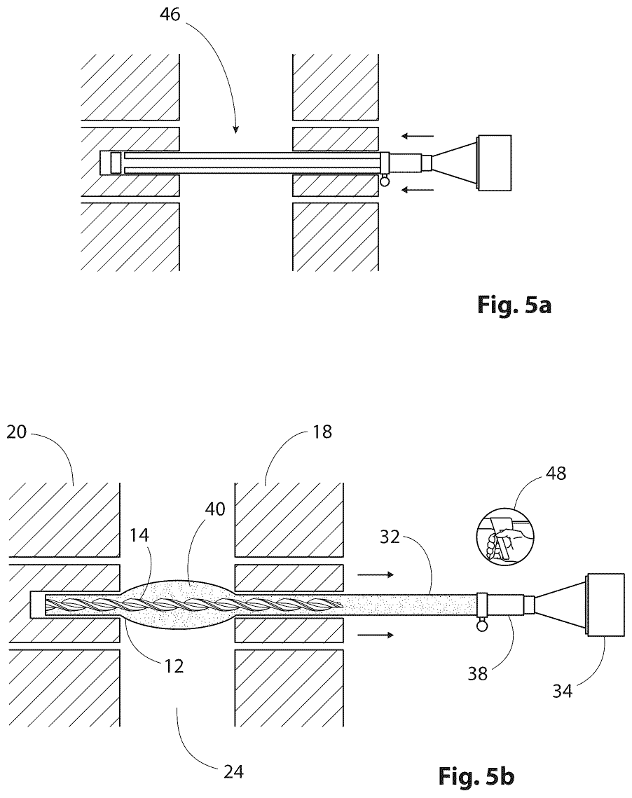

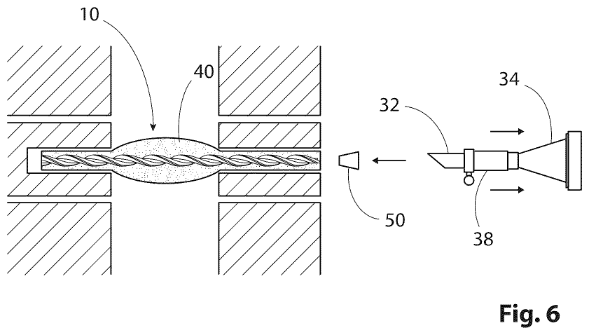

In the illustrated example the textile sleeve 12 is made of an elastic cotton textile material similar to tubigrip®. The material is flexible such that when it is installed in preformed cavity (described further below) the textile expands as it is filled with cementitious material e.g., grout such that it fills and adopts the inner profile of the cavity in which it is inserted. The textile sleeve 12 (see FIGS. 5b and 6) is configured to fill with cementitious material and bulge where the textile sleeve 12 is unsupported e.g., where the sleeve 12 bridges a gap 24 between two wall skins. The extent of filling and bulging is determined by the flexibility of the textile.

In the illustrated example the textile sleeve 12 is a section cut from a longer length e.g., 1 m length or a roll of textile sleeve. The sleeve 12 may be sealed at one end i.e., the leading end (as described further below).

In the illustrated example the tension member 14 is a length of helical spiral bar. In this example the helical spiral bar has an outer diameter of 12 mm to suit installation into a prepared cavity of around 22 to 24 mm in diameter. It will be appreciated the particular application and the structure being repaired will determine the dimensions required.

The configuration of the helical spiral bar 14 is such that cementitious grout (described further below) can encapsulate the surface profile of the bar 14 to provide excellent strength and no visible mark on the exterior of the structure e.g. a masonry wall in which the bar 14 is inserted.

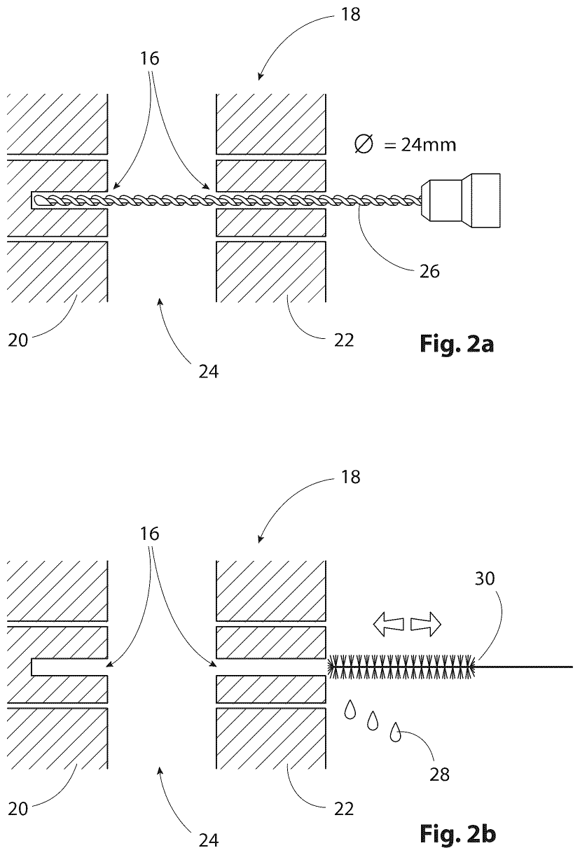

FIGS. 2a and 2b illustrate preparation of a substantially horizontal cavity 16 i.e., an elongate hole through a double skin brick wall (masonry cavity wall) 18 i.e., a wall including an inner skin of masonry 20 and an outer skin of masonry 22, where the inner and outer skins are separated by an air /p/ vertical cavity 24.

FIG. 2a shows the first step of preparing the wall 18 for installation of the sock anchor 10. In this example, the sock anchor 10 includes a 12 mm diameter helical spiral rod. As such a masonry drill 26 of between 22 and 24 mm diameter is used to drill the hole 16 through the outer skin 22 and partially into the inner skin 20.

FIG. 2b illustrates the step of cleaning the inner surface of the drilled cavity 16 with water 28 and a suitable brush 30 to remove debris such that a clean surface is provided for insertion of the sock anchor 10 and cementitious grout.

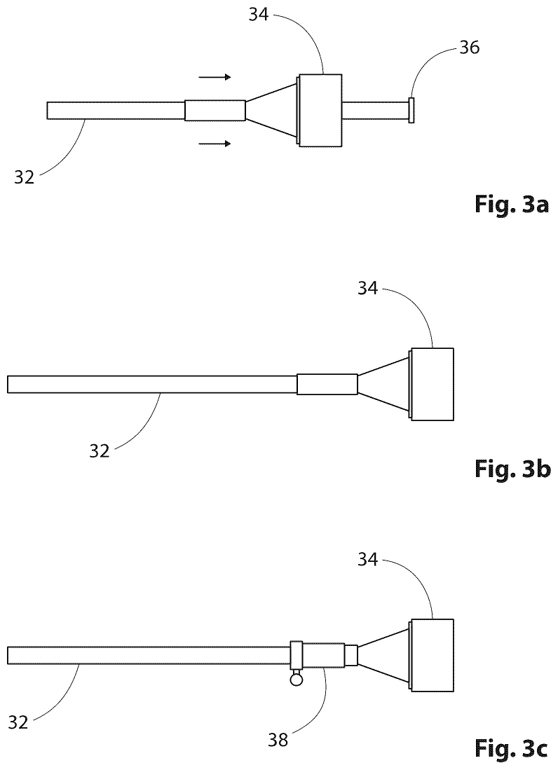

FIGS. 3a to 3c illustrate adapting a suitable injection gun to include an extension nozzle 32 i.e., a hollow tube that can be fully inserted in the drilled cavity 16 to aid installation of the sock anchor 10.

The extension nozzle 32 facilitates installation of the sock anchor 10 into the drilled cavity 16 as described further below with reference to FIGS. 5a and 5b.

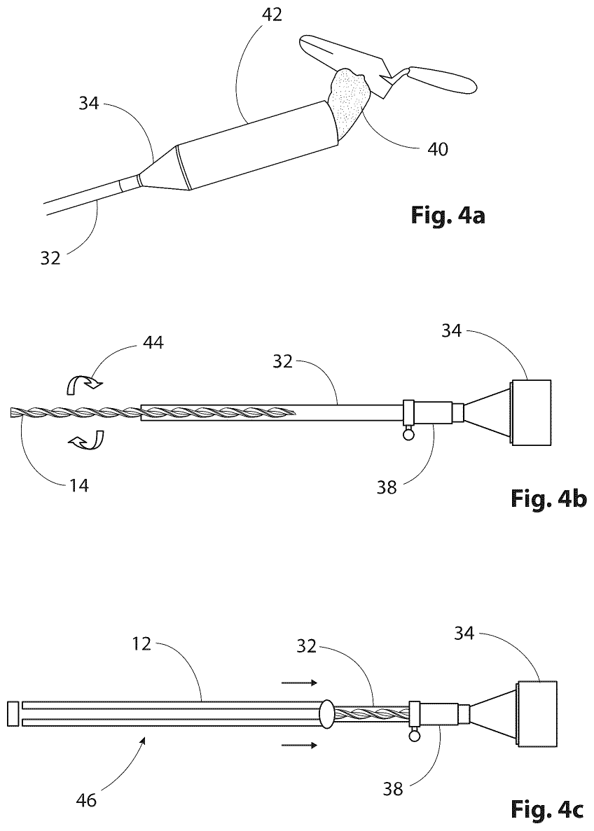

Preparation of an installation system, where the textile sleeve 12, extension nozzle 32 and the helical spiral rod 14 are inserted into the cavity 16 as a unit is described with reference to FIG. 3a to 3c and FIG. 4 to 4c.

As illustrated in FIG. 3a a nozzle 34 of a suitable injection gun is slid onto the extension nozzle 32. In this example, the extension nozzle 32 includes a flange 36, which acts as a stop relative to an inside surface of the nozzle 34 such that the extension nozzle 32 is secured internally. When fully installed (see FIG. 3b) the extension nozzle 32 is further secured to the nozzle 34 via a clamp 38 attached to the outside of the extension nozzle (FIG. 3c).

FIGS. 4a to 4c illustrate preparation of the installation mechanism, which includes preparing cementitious material 40 and assembling the components of the sock anchor 10 relative to the extension nozzle 32.

The cementitious material 40 e.g., grout is mixed according to installation requirements and is then trowelled into the body of the suitable injection gun 42 (FIG. 4a). The cementitious material 40 is then pumped to the end of the extension nozzle 32 before the helical spiral rod 14 is inserted into the extension nozzle (FIG. 4b). To insert the helical spiral rod 14 into the extension nozzle 32, which is filled with cementitious material 40, the helical spiral rod 14 is rotated 44 as it is inserted into the extension nozzle 32 such that the cementitious material 40 is displaced and encapsulates the helical spiral rod 14 as it is advances into the extension nozzle 32.

It will be appreciated the helical spiral rod 14 and the extension nozzle 32 are substantially the same length such that it is evident when the helical spiral rod 14 is fully inserted i.e., the exposed end of the helical rod 14 will be flush with the exposed end of the extension nozzle 32.

After insertion of the helical spiral rod/tension member 14 into the extension nozzle 32 the textile sleeve 12 is pulled over the outer surface of the extension nozzle 32 (FIG. 4c) such that the installation mechanism 46 is primed and ready to install the sock anchor 10 into the drilled cavity 16.

It will be appreciated the length of the extension nozzle 32, helical spiral rod 14 and the textile sleeve 12 should each correspond with the depth of the drilled cavity 16.

It will be appreciated the internal diameter of the textile sleeve 12 corresponds substantially with the external diameter of the extension nozzle 32.

The installation mechanism/assembly 46, which includes the textile sleeve 12, the extension nozzle 32 and the helical spiral rod 14 is inserted into the predrilled cavity 16. In the illustrated example, a gun with a trigger 48 connected to the nozzle 34 facilitates pumping more cementitious material 40 into the extension nozzle 32. This action simultaneously pushes cementitious material into the cavity 16 and displaces the helical spiral rod 14 from the leading end of the extension nozzle 32. Whilst the drilled cavity 16 and the textile sleeve 12 are filled with cementitious material pressure builds within the drilled cavity 16 and causes the extension nozzle 32 to retract from the cavity 16 such that the sock anchor 10 remains inside the drilled cavity 16 (FIG. 5a and FIG. 5b).

When the extension nozzle 32 is fully retracted, the sock anchor 10 is fully inserted and cementitious material 40 fills the drilled cavity 16 and fully encapsulates the helical spiral rod 14 a stopper 50 is inserted in the mouth of the drilled cavity 16 (FIG. 6).

The stopper 50 can be removed after a predetermined period of time during which time the cementitious material 40 at least partially sets. The indent that remains upon removal of the stopper 50 can be filled with material corresponding at least in colour to the structure in which the sock anchor 10 is installed such that the sock anchor 10 installation is not visible.

The embodiment described herein, is provided by way of example only, and many variations and modifications on such embodiments will be apparent to the skilled person and fall within the scope of the present invention, which is defined by the attached claims.

1. A sock anchor installation system comprising:
an elongate tension member;
a textile sleeve arranged to envelop the elongate tension member;
an elongate hollow tube attachable to one end of an injection mechanism configured to be filled with cementitious material;
wherein the textile sleeve is configured to be received over the elongate hollow tube and the elongate tension member is configured to be inserted into the elongate hollow tube,
wherein the elongate tension member, the textile sleeve and the elongate hollow tube are configured to be installed as a unit within a preformed cavity and the elongate tension member and the textile sleeve are configured to be substantially simultaneously released from the hollow tube into the preformed cavity upon injection of cementitious material from the injection mechanism into the hollow tube and into the preformed cavity.

2. The sock anchor installation system as claimed in claim 1, further comprising a stopper, operable to seal a mouth of the preformed cavity upon retraction of the hollow tube from the cavity.

3. The sock anchor installation system as claimed in claim 1, wherein the elongate tension member is a helical rod.

4. The sock anchor installation system as claimed in claim 1, or wherein the elongate tension member is a threaded rod.

5. The sock anchor installation system as claimed in claim 1, wherein the textile sleeve is configured to deform to take up the shape of the cavity in which it is inserted, when the cementitious material is injected into the cavity in which the textile sleeve and tension member are inserted.

6. The sock anchor installation system as claimed in claim 1, wherein the textile sleeve is made from an elastic textile.

7. A method of installing a sock anchor into a preformed cavity in a structure, the method comprising the steps of:
taking or cutting an elongate tension member to a length that corresponds with a depth of the preformed cavity;
taking or cutting a textile sleeve to a length that corresponds with a depth of the preformed cavity, wherein, in use the textile sleeve provides an outer sleeve of the installed sock anchor, and is arranged to envelop cementitious material and the inner elongate tension member;
taking or cutting an elongate hollow tube to a length that corresponds with a depth of the preformed cavity;
attaching the elongate hollow tube to an outlet end of an injection mechanism, wherein the injection mechanism is configured to contain and dispense cementitious material into the hollow tube and the preformed cavity;
priming the hollow tube until at least partially filled with cementitious material;
inserting the tension member into the hollow tube thereby coating the tension member in cementitious material;
applying the textile sleeve to the elongate hollow tube thereby encapsulating the hollow tube;
inserting, as a unit, the textile sleeve, the hollow tube and the tension member into the preformed cavity until fully inserted;
injecting cementitious material into the hollow tube and preformed cavity such that the cementitious material fills the preformed cavity and at the same time displaces the hollow tube from the preformed cavity whilst leaving the textile sleeve, tension member and cementitious material inside the preformed cavity.

8. The method as claimed in claim 7, further comprising plugging a mouth of the preformed cavity with a stopper after the hollow tube is removed.

9. The method as claimed in claim 8, further comprising removing the stopper and filling the mouth of the preformed cavity with a material that corresponds at least in colour with the structure in which the preformed cavity is formed.

10. The method as claimed in claim 7, further comprising preparatory steps of creating a preformed cavity in a structure and cleaning the preformed cavity before installation.
